(19) United States
(12) Patent Application Publication
(10) Pub. No.: US 2014/0032283 A1
(43) Pub. Date: Jan. 30, 2014

(54) System and method for Multi Merchant Next Hop Purchase Incentive Network

(71) Applicant: David Matthew Bradford, Great Neck, NY (US)

(72) Inventor: David Matthew Bradford, Great Neck, NY (US)

(21) Appl. No.: 13/940,762

(22) Filed: Jul. 12, 2013

Related U.S. Application Data
(60) Provisional application No. 61/677,400, filed on Jul. 30, 2012.

(51) Int. Cl. G06Q 20/08

(52) U.S. Cl. CPC G06Q 20/085
USPC 705/14.1; 705/39

(57) ABSTRACT

A system and method is disclosed that creates a next sale “buy one more time” network of merchants who, in one embodiment, are physically near each other, who promote a next purchase at a next merchant through the use of an electronic commerce medium with an incentive for a current merchant to become a paid sales agent for a next merchant.

### CROSS-REFERENCE TO RELATED APPLICATIONS

This application claims priority to U.S. provisional application No. 61/677,400 filed on Jul. 30, 2012, and entitled Next Hop Coupons.

### STATEMENT REGARDING FEDERALLY SPONSORED RESEARCH OR DEVELOPMENT

This invention was not made by an agency of the United States or under contract with an agency of the United States.

### REFERENCE TO SEQUENCE LISTING, A TABLE, OR A COMPUTER PROGRAM LISTING COMPACT DISC

Not Applicable

### BACKGROUND OF THE INVENTION

Coupons for mobile phones and incenting consumers to make purchases based upon coupons or offers involving cell phones are being tried in the industry by many different companies such as Isis, Microsoft, MasterCard, Visa, Apple, Google and more. All these attempts to integrate a coupon to initiate sale transactions into a mobile device are difficult to use, difficult to manage, and do not provide assurance that they will be acted upon or used. It is very difficult to measure the impact of merchant offerings. According to industry estimates, 98-99% of merchant offerings or promotions, are never actually exercised by consumers. As a result, there is a failure in the current marketplace to create an easy to use, easy to implement couponing or consumer incentive system to purchase a merchant's goods or services at the moment a consumer is already “out and about” interacting with a first merchant which merges both physical and virtual shopping purchases, that incents that first merchant to promote the goods or services of an second merchant in some unrelated business. Advantageously, the second merchant could be nearby the first merchant which greatly increases the likely hood the consumer will purchase from that second merchant.

ISIS and Google have announced their wallet where the incentives or coupons are just stored. There is no call to action for the consumer to commit to a sale for a second merchant, which this innovation provides. Also, this innovation provides a means and mechanism for an initiating merchant, we label herein Merchant-1, to get paid for the sales promotion effort, through the integration of an electronic commerce site which facilitates a sale for Merchant two, labeled herein Merchant-2.

It is well known that mass marketing and distribution of coupons produces a lot of wasted advertising. Coupons are sent in bulk to general consumers who do not commit to making any future purchase. Coupons are generally difficult to manage and easy to forget about even when it's clear they are applicable to an eligible purchase.

Disadvantages of Current Systems Regarding Coupons Used at Merchants

Google Wallet
A coupon is focused for use at one Point Of Sale (POS) merchant at a time. There is no direct linkage nor direct sales agent relationship between merchants. Merchants have a relationship with Google, not with each other. Each individual merchant is not trying to incent the consumer to spend more at another, different merchant. Google is interested in one physical location at a time, involving GPS tracking through the phone, or other means.
Google is trying to incent the consumer to go to each individual merchant or go into different merchant sites, physical or virtual. There is a problem here because there is little or no incentive for merchants to cooperate or link themselves together in a business relationship directly with another merchant. There is no system in place with the goal of promoting increased sales between merchants.
No one knows if the coupon or incentive for a merchant will later be used. The consumer may download the coupon into the Google wallet, and the merchant may have to pay a fee to Google for that fact, but the merchant has no assurance the coupon or incentive is going to be used by the consumer.

Isis Wallet
This wallet is focused on consumers obtaining coupons or discounts through the centralized Isis consortium.
Consumers are asked to manage their coupons or offers on their phone.
To use a coupon in his phone, the consumer is currently expected to individually activate and enable each coupon he wishes to use at a merchant. This is difficult, time consuming, and frustrating since the consumer may miss one coupon he wishes to use.
The coupons are not necessarily promoted as items that have a limited life, but rather the opposite. Consumers are expected to save and store them for later usage.
There is also no requirement that the consumer be “out and about” or interested in shopping at the moment or incented to go next to a nearby and unrelated merchant while he is in the “shopping mode.”
Furthermore, when a consumer obtains a coupon, there is no commitment from the consumer to ever use it.

Apple Passbook Application
As described, it also misses the point of creating an ecosystem of merchants to bring in business for one another. Apple does not allow merchants to enable their own networks between themselves. Apple provides an overarching centralized control of individualized offers and incentives for merchants and consumers. The merchants here are not relevant to one another and there are no business arrangements or sales incentives among them.
As is the problem with other listed providers, when a consumer obtains a coupon, there is again no commitment from the consumer to ever use it.

Amazon
The company in part provides merchandise grouping deals and suggestions of what other consumers purchased. These recommendations are all electronic-commerce based. Goods or services are virtual or are goods that are shipped. There is no connection to consumers purchasing at physical merchant locations. The Amazon system is not based on a physical or virtual location of a first merchant being a direct “sales agent” for subsequent merchant transactions. All transactions are not related to real live merchant locations that you as a consumer can interact with and actually visit. Amazon may provide incentives based on past electronic commerce purchase history, but not based on what physical merchants are nearby the first merchant. All these merchants are virtual ones.

Expedia and Other Internet Travel Related Sites
The site promotes travel package deals such as linkage of flight, plus hotel, plus amusement park, etc.
However, other additional merchant types that are nearby where the consumer is traveling or staying are not promoted, mentioned, or incented to participate.
Furthermore, transactions occur all online. Merchants that are in the vicinity of where the consumer is traveling to, do not promote each other's products/services, nor get paid for helping each other to increase aggregate sales.
Expedia provides the central control that assembles these packages together. Expedia bundles together deals from individual merchants. They are prepackaged and difficult for the consumer to add other merchants to the “traditional” package pairings like flight and hotel. Additional offers to consumers for merchants that are nearby the initial location are not directly controlled by the individual merchant who has chosen to be in the traditional bundling package. If there is a grouping of merchants (hotel, car rental, theme park admission), this bundling of merchants is fixed, static, and limited.
Expedia does not know the user is in fact in the buying and not just the browsing mode.

LevelUp
The focus is on only one merchant at a time, not merchants helping each other sell additional products.
If a new customer transacts with a merchant using their incentive, LevelUp pays the bank transaction fee and instead charges the merchant a LevelUp fee based on the value of the consumer incentive offer. Not any incentive for merchants to promote other merchants

Therefore it is desirable to provide a coupon or purchase incentive which leads to an immediate sale which uses and employs mobile phones, or other internet connected devices, to enfranchise a network of merchants to promote each other's businesses. This invention provides a payment/incentive for merchants to do so which commits the consumer at the time of the incentive/next purchase presentation to actually buy the offered next purchase and opt-in to a deal right then.

Embodiments of the present invention relate to systems, methods, and processes, computer program code, and means for using mobile phones and other devices to initiate a guaranteed payment for a Next-Merchant in a network of merchants who are, in one embodiment, advantageously physically nearby each other.

### BRIEF SUMMARY OF THE INVENTION

A system that incents consumers to make more purchases at physical or virtual merchant locations who may be geographically nearby one another and provides an approved sale of Merchant-2 goods while the consumer is at Merchant-1's location (physical or electronic commerce). By using this separate incentive system, there is proof provided to Merchant-1 that the Merchant-2's deal offered at Merchant-1 was consumed and that Merchant-2 will pay Merchant-1 a fee for the Merchant-2 transaction that was initiated through Merchant-1's location.

While the user has completed or is in the process of completing a sale at the first Current-Merchant, either physically or virtually, the user is presented with an opportunity to initiate and commit to an additional purchase, through the use of a “Next-Hop sale coupon.” This special sale transaction allows a consumer to buy something through electronic commerce means using for example the consumer's own cell phone while he/she is physically in range of the Current-Merchant's point of sale environment. However, even if a consumer did not have an enabled cell phone or similarly internet or web capable device at the moment of purchase, the merchant could easily provide access to one. For example, a merchant could decide to make available their own tablet computer located at the point of sale location. Whatever the device used, merchants ultimately will be able make the choice on how they want to enable their customers o submit electronic commerce payments for a Next Hop sale for a Next-Merchant.

An efficient version of this system would encourage consumers to tap their NFC enabled cell phones to an NFC-tag on a poster located in the area of the initial merchant's physical point of sale. After tapping the tag in the poster, the consumer's NFC phone advantageously presents the “Next-Hop purchase coupon” which presents a valuable sales offer on the consumer's mobile phone for another different merchant. The “Next-Hop” purchase web page that the consumer is brought to in order to complete the additional sale is encoded in the tapped NFC tag on the poster at the Current-Merchant using “NFC Forum” standard processes in the consumer's NFC phone.

In this invention, data in the tag identifies the Next-Merchant initiating and providing the web page embedded with an NFC chip of the poster with a new deal for the consumer to buy. The purchase transaction is identified and logged by the system through any means know in the art such as assigning a unique merchant-id for each merchant in this system and, for example, sending the transaction date and time, consumer id, current and next merchant-ids in the data stream to the web page of the “Next-Hop purchase” and saving the transaction information in a log file that is then used by the system to process and pay system sales agent fees

The consumer commits to the transaction for goods and services at a Next-Merchant while they are at a Current-Merchant through electronic commerce means.

In one embodiment, the user commits to this additional next transaction for a merchant close in physical proximity to the current physical merchant.

Various methods, both at physical point of sale or at an electronic commerce merchant site, may be employed to initiate the first transaction in a chain or electronic commerce purchase transactions from one merchant in this system to a next merchant in the system.

Through this invention, an electronic commerce site is able to link to a physical merchant location to initiate sale transactions for its own physical or virtual location. creating a business relationship where the first merchant in the chain becomes a “paid sales agent” for the Next-Merchant's transaction.

The beginning merchant is incented to participate in the promotion and sale of another merchant's product especially when the next merchant is physically nearby, and/or nearby as defined by that particular community of interest.

In one preferred embodiment, the incentive or sale for the subsequent merchant is valid for some limited amount of time. For example, the offer might be a great deal that is valid for a short period of time so the consumer needs to act on and commit to the offer now.

Because the consumer is at a merchant, he/she is by definition “out and about” or in a “purchasing mood.” This spending state of mind increases the likelihood that the consumer will continue buying, because the “Next-Hop” deal may be highly compelling and is only available when using this invention's merchant incentive system.

This invention provides a financial incentive for the first Merchant-1 to offer the services of subsequent additional nearby merchants (Merchant-2 or Merchant-3) that need to be initiated while the consumer is at Merchant-1's location (physical or virtual). No one is doing this today.

This invention provides an incentive to consumers to make an additional purchase using electronic commerce means of Merchant-2's products/services while the consumer is in the process or has completed a purchase at Merchant-1's location.

This invention solves an unrecognized problem. This system knows the user is in fact in the buying mood. The next coupon, offer or deal comes only when a consumer is interacting with a merchant or has completed a sale at the Current-Merchant. Afterwards, this system presents an offer/coupon to the consumer to purchase something, in a preferred embodiment, from a next “nearby” merchant.

This system rewards consumers when they are at the Current-Merchant site or have bought something at the Current-Merchant, and then offers coupon/incentives which they have to buy or commit to at that moment. This systems purchase incentive needs to be used in the present, long waits to commit to them are not allowed. The length of time allowed for a commit is set by the merchant offering the coupon/incentive, but should not be days or many days later.

This invention provides an unappreciated advantage. Everyone is implementing a duplication of existing physical coupons and not linking purchase offers between merchant as this invention does.

This invention provides an un-suggested combination of ideas. For the first time herein is a system that integrates an electronic commerce transaction conducted right after and linked to the previous transaction, which could be a real world physical location transaction. The consumer is at Merchant-1's location (physical or web) and the consumer is offered a subsequent and distinct second follow up offer to transact, as an electronic commerce transaction, for Merchant-2 products or services.

What payment method or payment means the consumer uses is not relevant to our merchant network system herein. Any and all payments types and means of payment (such as credit card, debit card, pre-paid debit, check, loyalty point values, PayPal, etc) is not relevant to the merchant network scheme of this innovation.

This invention creates value by establishing a link from a Current-Merchant to a subsequent merchant in a pre-created chain where two merchants (the Current-Merchant and the Next-Merchant in the chain) are in a pre-arranged business relationship with each other. The referring merchant provides the Next-Merchant with a new customer, and as a result, this system pays a fee to the referring merchant. This creates a beneficial incentive for merchants in the scheme to refer business to each other because they are receiving payments for their efforts.

What businesses are doing today is offering one shot deals for use at one merchant. This invention provides an incentive for a consumer to buy “just one more time.” This ignites the existing “buying mood” of the customer. This system provides the chain reaction network which propels additional sales. No one is doing this in any of the schemes currently being offered in the marketplace.

While the customer has completed or is in the process of completing a purchase transaction at the first merchant, the consumer is in the “buying and spending mood.” At this time, this system enables a Next-Merchant to present purchase offers to the consumer can extend that buying mood to one additional merchant and at a maximum a conceptually unlimited chain of offerings.

Each individual merchant is motivated to incent the consumer to spend more at another, different merchant.

Each purchase at a “Next-Hop” offering merchant influences the consumer's next purchase based on the Current-Merchant's physical or virtual location.

Each merchant decides to join the merchant “Next-Hop” system and become a sales agent to those merchants connected to it.

This invention enables fluid changes in a multi-linked, multi-nodal network of merchants who offer deals for each others' products or services. The consumer is provided the Next-Hop merchant in a network of different merchant locations when he arrives (physically or virtually) at a merchant location.

Consumers customize or build their own packages of merchant offerings themselves as they hop from one merchant location to another. This allows for a dynamic bundle of varied deals to take shape which are ultimately tailored to a specific consumers needs. Within this buyer driven model, merchants will similarly have the ability to present multiple versions of their own offers based on purchasing patterns for the hour of day, days of the week, time of year, etc.

Offerings provided to a consumer for the Next-Merchant in the chain can use analytics based on such attributes as time of day, day of week, month, year, holidays, activity type, or commonly associated activity groupings (such as movie hop to a pizza place, then a bar), historical patterns of usage, distance between merchants, and so on.

This system provides a network of merchants at more than one physical location. However, if desired, the system can also be deployed to integrate virtual merchants' locations, especially as a starting point, per FIG. 2.

In one embodiment, the system uses the physical location of the merchant and the location of the next physical merchant to entice the consumer to continue his buying and spending. Offers at a Next-Merchant may be so compelling that the consumer will go to that Next-Merchant.

This innovation adds moments of serendipity, surprise, and delight to a shopping experience that consumers will find enticing. These deal/offers are unknown to consumers until they are at a merchant who participates in this system. In a sense, the consumer receives a “present” or a gift of a great purchase offer for a “nearby” merchant who can entice the consumer to change his behavior now or at least commit to the sale now.

This invention does not by design have privacy concerns because these offers are being presented based upon a consumer buying something at an initial merchant. There is no requirement that offers be based on a consumer's individual purchasing pattern or that the consumer reveal or supply personally identifiable information.

This system is the only system that offers the option to create a consumer chosen “pathway” through a network of merchants with offers.

The system allows for fluid changes in a multi-tiered network of connected merchants. Many deals can be offered at a particular merchant. It is up to each merchant to decide how many links to other merchants they support from their location. This network of merchants is dynamic. The consumer discovers the network of different merchant locations when arriving at anyone of the merchants in the system. At that point, the consumer sees the supported offers from each merchant in the network.

Customers for the first time can customize or build their own package of merchant offerings. There is no pre-configured way for a consumer to navigate through the connected merchants. It is not a static pre-established package of a bundle of deals, like Expedia and other bundling web sites for travel related merchants, where the bundled package of deals for example is set to be an airline, a hotel, a rental car and no other merchant types.

The Next-Merchant in the chain is getting the commitment of the consumer to the sale at the previous merchant. Retailers today make offers to consumers all the time which never get utilized. For this invention, for a short period of time while you are at the starting merchant, you must take the deal and pay for it right there, right now, through electronic commerce means.

In one preferred embodiment the consumer/user would do these actions on his own mobile device that is internet connected, but there is no requirement it be so. Other techniques and devices used to pay may be used.

The consumer does not need to download or keep track of coupons. We offer “buy now” transaction offers which are not dormant “maybe later” coupons as is presently promoted by current systems.

Another key concept is merchant choice where the merchant decides who it wants to promote next in the chain. Is the promoting of the Next-Merchant worth the fee they receive? Tiffany's jewelry store will not be forced to cross promote a pizza merchant nearby but it can choose to do so if it finds it desirable and profitable.

An additional benefit for this system is incentive/promotion efficiency. Essentially, customers choose the purchases they want to make while at the first merchant. Therefore at the second merchant, customers do not have to fumble around and “find” a coupon on their phone and activate it. The consumer has chosen already. Consumers completed the deal previously.

There is minimal or no risk that the sales incentive is not applied.

This system allows for both physical and virtual locations to be the initiating merchant in the network chain. In one preferred embodiment, the system involves at least one merchant with a physical location where goods/services are supplied to the consumer.

Furthermore, the system provides for a cascading payment structure.

Merchants closer to the beginning of the chain are paid a fee by later merchants who benefitted from the prior referral. For example, if merchant A refers a customer to B and B refers that same customer to C, C pays both A and B a fee.

Fees going to the merchants as sales agents may vary greatly and are flexible. Different fees/rates can be paid between merchants per different bi-lateral agreements made by each merchant pair. For example, if the initiating merchant got a new customer to travel 10 miles to the Next-Merchant, the initiating merchant could get a larger referral fee for drawing business which otherwise would be harder to attract than a Merchant-10 feet away.

### BRIEF DESCRIPTION OF SEVERAL VIEWS OF THE DRAWINGS

FIG. 1: An overall view of a consumer with a NFC enabled cell phone interacting with an “NFC Forum” or similar tag that is near a first Current-Merchant point of sale area.

FIG. 2: Hybrid Transactions between Virtual Merchant Locations and Physical Merchants Locations

FIG. 2 is a diagram demonstrating how the system operates in a hybrid mode where an electronic commerce merchant initiates the chain of “Next-Hop” transactions.

FIG. 3: All Virtual Internet Locations

FIG. 3 is a diagram demonstrating how this system operates in an all or mostly virtual electronic commerce merchant world which initiates and continues the chain of Next-Hop online transactions.

FIG. 4: Cascading Fee Payment System
This diagram shows the flow of the “sales agent fee” payment from one merchant to another.

FIG. 5: System Process Flow shows the overall flow of the system.

### DETAILED DESCRIPTION OF THE INVENTION

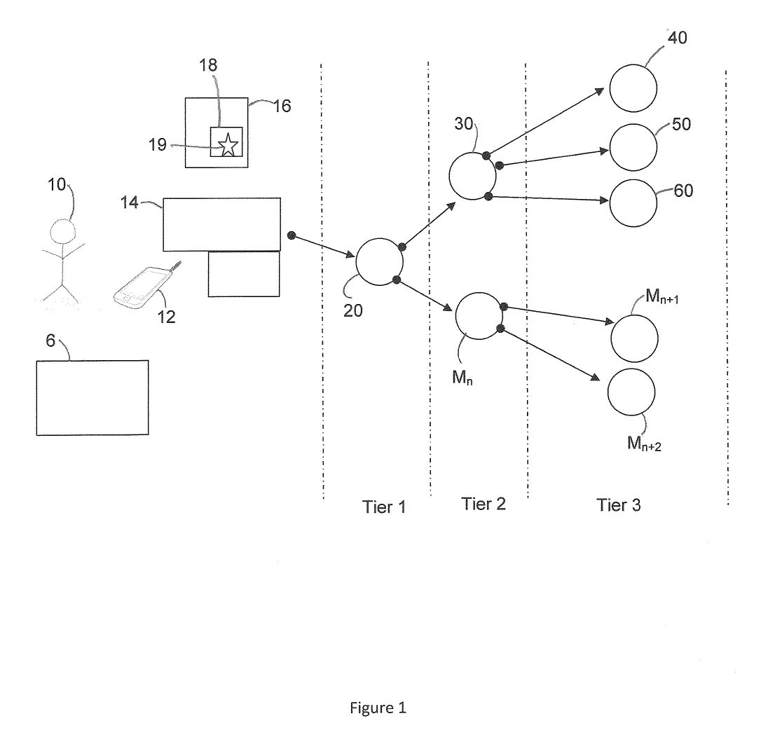

Advantages of the invention may become apparent after reading the following detailed description and referencing to the component listing, definition of an EC-TID device, and drawings of FIGS. 1-5.

The phrases Merchant-1, Current-Merchant, current merchant are synonymous.

The phrases Merchant-2, Next-Merchant, next merchant are also synonymous.

One or more specific embodiments of this present invention are described below. Not all features are described but it should be appreciated that different alternative implementations/designs can be made to achieve the intended goals such as compliance with the overall architecture and features of the invention which can be implemented in different ways. Anyone skilled in the art of providing offers or coupons and then completing a sale using an incentive coupon or purchase offer will easily be able to build this system.

Components of the Next Hop Purchase System:
Component 1) An “Electronic Commerce Transaction Initiating Device” (EC-TID) may be a merchant or consumer provided device that can initiate and complete an electronic commerce purchase transaction such as from a smart phone, laptop portable computer, tablet computer, Personal Computer (PC), or other device that enables the consumer to complete a purchase for a Next-Merchant while at the Current-Merchant using electronic commerce means.
In a preferred embodiment, the EC-TID Device component is the consumer's own smart phone that has Near Field Communication enabled technology, by touching the NFC enabled smart phone onto a NFC smart poster which has an embedded NFC tag that is read by the NFC smart phone, which NFC tag transmits an Internet URL to the smart phone, which smart phone is capable of connecting to the obtained Internet site (URL), the smart phone then displaying the Internet web page, the consumer then choosing the item(s) offered for sale, then completing an electronic commerce purchase of the item(s), then getting a proof of purchase receipt of any acceptable kind know in the art, which can be used to provide to the Next-Merchant in order to obtain the purchased item.
Component 2) Consumer entity information component for each consumer who uses the system. For example the Consumer-id may be an identifier that the consumer already has such as their email id, plus an optional system password, or the consumer when registering can create a new unique consumer user id in this system.
This Consumer-id is used to track a possible series of purchases that the consumer could make using this invention within a system criteria, such as a particular time frame and/or geographic boundary that would be used to determine that a particular purchase is a first purchase in a chain of purchases in this system or not, per the criteria.
If this particular purchase is not the initial purchase, the system searches purchases made by the Consumer-id within the system criteria and saves and tracks the chain of Merchant ids (Current-Merchant id, Next-Merchant id transaction pairs with this same Consumer-id within the system time or distance criteria) involved so that each merchant in the chain of purchases by this consumer id in this system can then receive their cascading chain sales agent commission.
Component 3) Current-Merchant id information component for each Current-Merchant which maintains the following data items:
Current-Merchant system id,
List of each Next-Merchant-id and their corresponding internet web site used for this Current-Merchant pairing relationship;
Sales agent fee for possible previous merchants to this Current-Merchant and sales commission terms to pay for previous merchants as previous sales agents who precipitated this particular sale transaction at this particular Current-Merchant in a chain of sale transactions using this system. This previous merchant sales agent fee is paid by the current merchant to an agreed system number of previous merchants who using system criteria such as time or distance or other mutually agreed criteria are considered to have helped the consumer visit the Current-Merchant. This payment amount for previous merchants is taken out of/from the sales agent fee amount the Current-Merchant receives from the Next-Merchant for the consumer purchase transaction at the Next-Merchant.
Component 4) Next-Merchant component which maintains the following data items: A system merchant-id; List(s) of items/services offered for sale by this Next-Merchant for consumer's at each particular Current-Merchant connected to this Next-Merchant; Sales commission terms for this Next-Merchant to Current-Merchant pair (amount or percent, or other payment terms/methods); Electronic commerce payment types and methods offered (can be different than the payment types offered by the Current-Merchant); Time when the Next-Merchant sales offer was made to the consumer; Time of sale completion (possible items include sale day, sale week number, month, year, hour (time element variable), Optional sales activity type, activity history (repeat consumer), Means to approve an electronic commerce purchase transaction for the payment type picked by the consumer.
Note that a Current-Merchant advantageously can also be a Next-Merchant for other merchants in the system, but is not required to be.
Component 5) List of purchases made by each consumer-id initiated from a particular Current-Merchant-id for goods/services of a Next-Merchant id, which if more than a single purchase within a defined period of time or other system limit, creates a chain of purchases. In a preferred embodiment, this component is a simple list of completed transactions where each line in the list of completed transactions has the particular consumer-id, the Current-Merchant id, the Next-Merchant id, transaction amount of purchase, transaction currency of purchase, the time of purchase offer, the time of purchase completion which the system uses to track that this purchase is within the agreed sale commitment time frame. The System determines if the transaction is part of a chain of sale transactions of completed transactions that meets system criteria for a chain when the same customer id is in the list of saved transactions more than once within the defined criteria such as time or distance which triggers an associated sales agent commission to be paid to previous merchant id(s) found with the same customer id that meet the criteria.
Component 6) Merchant sales agent fee component which cascades from a Next-Merchant to a Current-Merchant and then to possible previous merchants for a chain of consumer-id purchases in their chain of purchases
Component 7) Component that offers goods or services to purchase from an EC-TID device at a Current-Merchant using electronic commerce transaction means and where the consumer completes the purchase. The completed sale information with the initiating Current-Merchant id and Next-Merchant id, sale amount and other data is written to the completed sale transaction log of component 5 for fee processing.
Component 8) Consumer contact component, such as sending an email or SMS text message by mobile phone of completed sale information to the consumer
Component 9) Sales receipt issuing and dissemination component to the Consumer, Current-Merchant, Next-Merchant for each purchase transaction made from an EC-TID device.

Turning to FIG. 1 the system is shown from the view of a consumer with a NFC enabled cell phone.

An NFC tag is in or on a poster at the first/starting merchant who is promoting, as a sales agent, an offer or incentive or promotion for a nearby second Next-Merchant.

In this preferred embodiment a person 10 holding an electronic device, like a cell phone 12, will pay using any method (credit card, debit, cash, etc. . . . ) for the first merchant's 20 product or service. Additionally, at the Merchant-20 point of sale 14, there is available a poster 16 or device of similar nature with an NFC Forum type tag 18. The embedded tag 18 within that has the web address of an incentive. The incentive 19 contains additional value such as a coupon or great deal for merchant 30, a percent off at merchant 30, VIP access at merchant 30 as an inducement to commit to purchase, special line busting privileges at merchant 30, or similar incentive value at merchant 30. Advantageously, consumer 10 would have the option of picking from a number of posters 16 with his NFC enabled device that are being offered by Merchant-20 for merchants in addition to merchant 30. In one preferred embodiment, merchant 30 is nearby in proximity to Merchant-20 to facilitate and greatly increase the consumer's interest in using the coupon/offer for merchant 30 close by. In fact, consumer 10 has shown he is in the “buying mode” and in the “buying area” since he is already buying at Merchant-20.

The consumer is out and about in the buying mood, so the consumer can be given a good deal from the next-merchant in the chain of “Next-Hop” merchants in the larger network of “Next-Hop” merchants.

This incentive, or other value such as a 50% off coupon, needs to be committed to within a short time frame, preferably while customer 10 is in or around Merchant-20's point of sale 14 environment.

At this point consumer 10 using device 12 with the instructions included on merchant 30's electronic commerce offer page, commits/purchases the goods or services of merchant 30 who is preferably nearby Merchant-20. Merchant 30 then sends an electronic commerce receipt to the consumer's cell phone 12 using means known in the art, such as an email or SMS message. It is important that the commitment to purchase be conducted while consumer 10 is at or near Merchant-20.

This commitment is preferred to be made from consumer device 12 which has internet connectivity and which is enabled to conduct an electronic commerce payment transaction for goods and services being offered through electronic commerce means from merchant 30.

Other means to pay for the goods or services of merchant 30 would be possible through a device available at Merchant-20, such as a separate and distinct internet connected device. In this diagram, an Apple iPad tablet device 6 has been provided by the merchant. Other internet connected personal computers, tablets, or devices that allow remote purchases by customer 10 to be committed are also possible.

Another example of an implementation of this invention is enabling the Merchant-20 point of sale environment to simply provide a physical paper coupon printed out along with the consumer receipt when Merchant-20 completes its sale with consumer 10. This extra or appended printout transaction receipt would provide all the detail needed for the particular consumer to use within a short time frame at any convenient internet connected device available, including but not limited to his own personal device, to commit and purchase the merchant 30 goods or services. Consumers would then input or supply, for example, a unique transaction code printed on the Merchant-20 issued coupon/offer which indicates in this system database that Merchant-20 is the coupon/offer originator along with other merchant 30 transaction details which may include such items as the coupon's value, consumer's cell phone number, transaction price, date, time, location, etc.

A key component of this invention is that consumer 10 commits and pays for the value/offer/coupon 19 “in present time” and consumer 10 does not have the option to treat it as a traditional “maybe later” coupon which may never be used in the future. Additionally, customer 10 can't save or pass along the coupon 19 to another person. Customer 10 only gets coupon 19 when they are at Merchant-20.

Preferentially, the coupon/offer would be linked to consumer 10's phone number so it could be used by that particular consumer 10's phone. After consumer 10 has committed to the merchant 30 deal, Merchant-20 is noted by this invention that it was the sales agent for merchant 30 using techniques known in the art.

An authentication process that verifies the receipt for merchant 30 distributed to consumer 10 through this invention is not tampered with or modified using means known in the art such as employing a secure hash algorithm (SHA) over the coupon and transaction details, or other means such as issuing a unique barcode or transaction code issued by merchant 30. The system needs to keep track of sales initiated at Merchant-20 and will communicate this information to merchant 30 to guarantee Merchant-20 receives its sales agent fee. For instance, one implementation can include unique merchant ID's in the data streams to satisfy this requirement.

At some time in the future, advantageously soon after transacting at Merchant-20, consumer 10 goes physically or virtually to merchant 30 to redeem and obtain the discounted value or service that he/she purchased when at Merchant-20. If physical, consumer 10 would show a receipt obtained for example through electronic or other means to merchant 30 to indicate consumer 10 is the rightful recipient.

This receipt could be a barcode on the phone or paper receipt printed out at Merchant-20. As an example, the redeemed offer could be a coupon that reduces the price of the goods or service, an offer of VIP access at merchant 30, special line busting privileges at merchant 30, or similar incentive values known in the industry.

For instance, for pre-paying for merchant 30 at Merchant-20 ahead of time, a food like pizza could be made in advance reducing consumer 10's waiting time, or have a discounted price, or both.

A key component of this invention is the incentive infrastructure created between Merchant-20 and merchant 30. The system provides a means for merchant 30 to pay Merchant-20 a sales agent fee which has been agreed per a bilateral arrangement prior where they could preferentially cross promote or unilaterally promote the other's service. This is the first time where Merchant-20 has a clear economic incentive to promote merchant 30's services which would be processed through this system. The fee structure and incentive for Merchant-20 could fluctuate based on a number of variables identified and previously agreed upon between Merchant-20 and merchant 30.

Separate Transactions

Another key attribute of one preferred embodiment of this system is that the sale of the product or services of merchant 30 is separate and distinct and not bundled with the sale transaction of Merchant-20. They are not required to be separate transactions. However, when the transactions are separate there is a clear demarcation between the two transactions and the method that is used to pay at Merchant-20 has no necessary bearing or relation to the method to pay for goods or services redeemed at merchant 30. This system does not require bundling the payments for Merchant-20 and 30 together. They are not required to be joined in a singular payment transaction later to be divided after the purchase has been made. When separate, it is an easier and practical implementation which is effortless to manage, and allows for different incentives to be provided, possibly by different payment methods to be advertised and promoted at each merchant.

For example, if merchant 30 wanted to offer a better deal if customer 10 paid with PayPal, merchant 30 can do so without consulting or committing Merchant-20 to also use PayPal. As a consumer, if you pay for movie tickets with PayPal, you get a free popcorn or if you pay with a Discover card, you get 50% off the price of pizza. In this invention, merchants are free to negotiate with payment method providers for specific deals that are the most beneficial to them.

This separate transaction design also advantageously allows customer 10 to reject Merchant-20's goods or services and instead choose to only buy merchant 30's goods or services while at the location of Merchant-20.

Finally, in FIG. 1 after consumer 10 has purchased at Merchant-20 and then 30, the process of offers continues on to merchant 40, 50, 60 etc. until consumer 10's buying mood is over.

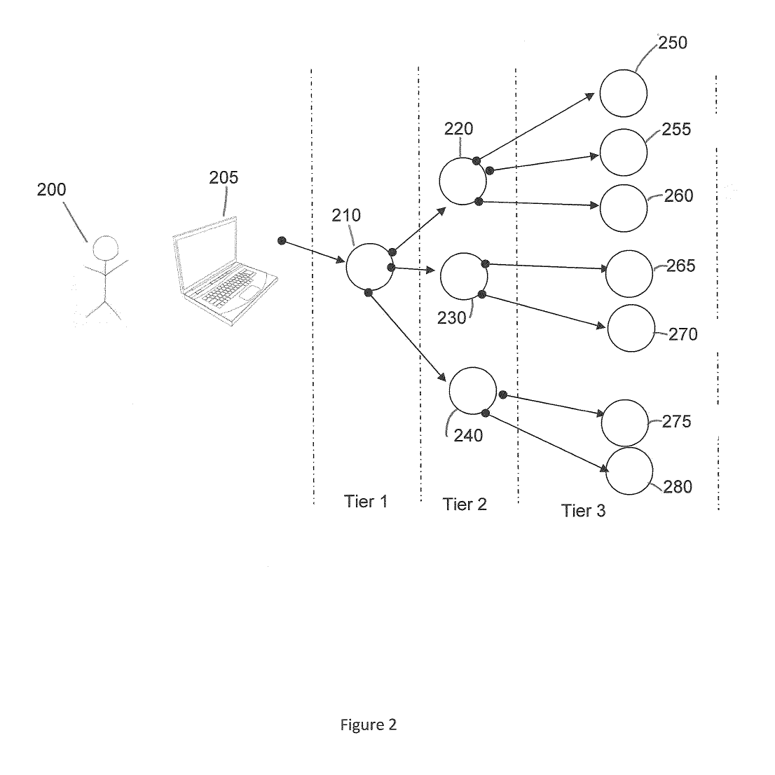

Turning to FIG. 2—Hybrid Transactions between Virtual Merchant Locations and Physical Merchant Locations. FIG. 2 is a diagram demonstrating how this system operates in a hybrid mode where an electronic commerce merchant initiates the chain of “Next-Hop” transactions.

In this embodiment, the consumer 200 uses an internet connected device 205 to make the first purchase online for goods or services at a merchant who will fulfill the order at a physical location. For example, at the completion of the transaction at Merchant-210, consumer 200 is shown a list of Next-Hop merchants such as merchants 220, 230, and 240. Consumer 200 then chooses one or more Next-Hop purchases to investigate/evaluate for a commitment to a transaction in the near future which is a key attribute of this innovative system.

A key benefit of this system is that the consumer is presented offers conceptually forever. Each merchant extends multiple offers of Next-Hop purchases from Tier-1 merchants, to Tier-2 merchants, to Tier-3 merchants and so on in a massive chain reaction. A number of offers will continue on so long as consumer 200 is willing to commit to another purchase.

Advantageously, when consumer 200 is at a Tier-1 merchant and proceeds to a Tier-2 zone with multiple merchants offers, consumer 200 will have the ability to go backwards to the prior tier and accept a different chain of purchases using for example a back button.

However, consumer 200 is not permitted to hold these offers indefinitely. All promotion offers have to be used right now or by a time limit set by the system. In other words, there is a commitment window to purchase these offers.

Moreover, each promotion offer is a separate and distinct committed transaction so that the payment for a particular merchant is transferred to that offering merchant's account. Each merchants payment is an independent payment transaction and there is no requirement that payment means, modes, or types be the same as previous or subsequent transactions with other merchants in other tiers.

Merchants are linked in the promotional stage but not required to use the same payment method as used at other merchants. This allows merchants to freely use different payment types as each merchant independently desires.

Another key part of this invention is that Merchant-210, for example, will receive a sales agent commission/fee from merchants 220, 230, and 240. Merchant-210 also could receive a preferentially lower sales agent fee for facilitating sales at merchants farther down the chain like merchants 250, 255, and 260.

Consumers can tailor and build their own purchase package or bundle deals so that they can customize their itinerary for a targeted geography in advance, before arriving at the physical location. This invention is better than an Internet Travelocity type concept, for example, that constrains the discounted package to a set list of merchants such as a traditional promotion travel bundle that includes a flight ticket, hotel, car rental, and possibly an amusement park entry. This system allows the consumer to add on additional customized merchant offerings as Next-Hop purchases to expand the purchasing possibilities. For example, consumers could add miniature golf, a local restaurant, or other activity or services that are traditionally ignored in bundles of electronic commerce site packages.

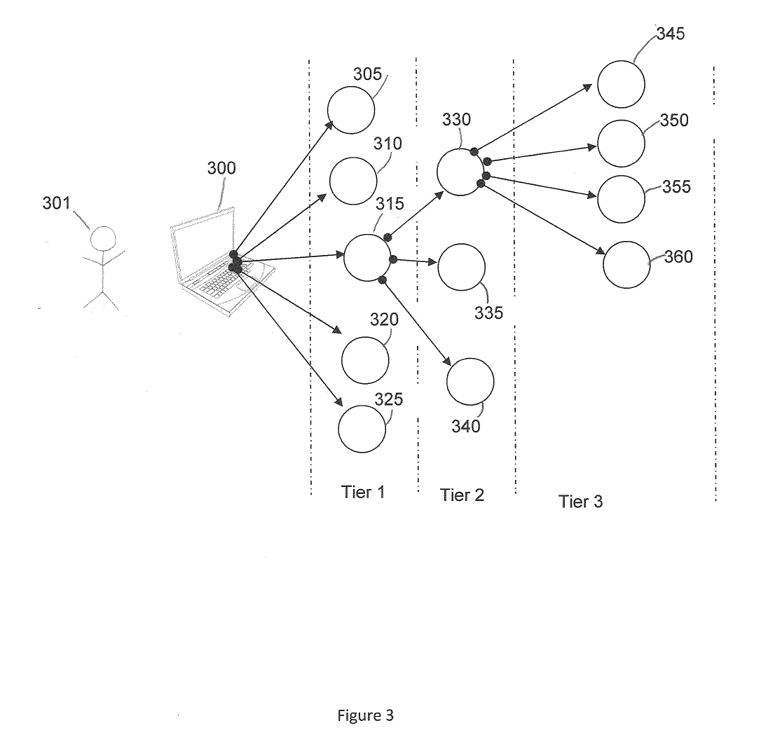

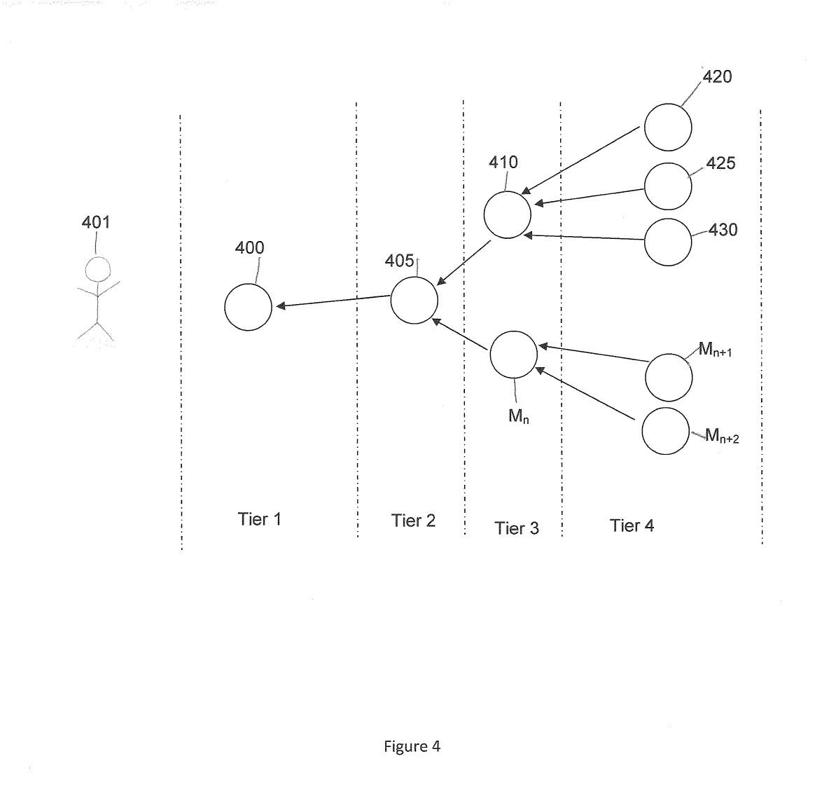

Turning to FIG. 3—All Virtual Internet Locations.

FIG. 3 is a diagram demonstrating how this system operates in an all or mostly virtual electronic commerce merchant world which initiates and continues the chain of Next-Hop online transactions.

In this model, the 301 consumer uses an internet or private network connected device 300 to make the first purchase online for goods or services at 315 merchant. The consumer is then made a series of offers from multiple Tier-2 merchants (330, 335, 340). At that point, the consumer then chooses to buy 330 merchant's online product or service. As explained in FIG. 2, the offer possibilities will continue onward to the next Tier level of merchants so long as the consumer would like to make more purchases.

The distinction between FIG. 2 and FIG. 3 is that FIG. 3 follows all the same principles, but can operate in an all virtual electronic commerce environment where the merchants involved don't have a real world physical presence or offer real world goods or services.

In this embodiment, the system will present Next-Hop purchases to link to other Tier-2 and Tier-3 online merchants. The same rules apply regarding sales agent fees. Preferably, subsequent merchant payment transactions continue to be distinct and independent from each other.

An alternative embodiment is a mixture of some merchants with physical locations, some with a virtual online location, or a combination of both real world and virtual.

Turning to FIG. 4—Cascading Fee Payment System.

This diagram shows the flow of the “sales agent fee” payment from one merchant to another.

In its most basic form, a referring merchant will receive a fee in return for bringing business to another merchant. So when consumer 401 spends money for goods or services at merchant 400, and then while at merchant 400, decides to spend more money for merchant 405's product as well, merchant 405 will pay a set sales agent fee to merchant 400 as a reward. In this simplified example, merchant 400 gets all of the fee paid by merchant 405 for bringing in the new business.

In another example, consumer 401 has committed to buy products or services from merchant 400, merchant 405, and merchant 410. These purchases may happen at various physical locations, internet locations, and at different times. However, they all involve a commitment to buy from consumer 401 when he elects to transact with each individual merchant.

Here, consumer 401 makes an initial purchase at merchant 400. During or shortly thereafter, as consumer 401 completes the merchant 400 transaction, consumer 401 is then offered a deal for goods or services at nearby merchant 405, which he accepts. When consumer 401 commits to buying merchant 405's product, he is encouraged yet again to act on another deal to buy merchant 410's product. In this example, consumer 401 decides to buy merchant 410's product as well.

When consumer 401 spends money for goods or services at multiple merchant locations like at merchant 400, merchant 405, and merchant 410, the flow of fees reflect that consumer's journey through the network of merchants and their respective tiers in the system relative to the consumer. The fee paid by merchant 405 to merchant 400 can fluctuate based on such parameters as day, week, month, year, hour (time element variable), activity type, activity history (repeat consumer), etc.

Ideally, merchant 410 would pay two merchant sales agent fees, one to merchant 405 for being “one-hop” away and another to merchant 400 for being “two-hops” away (this fee would preferably be less than the fee paid to merchant 405).

However, the fee paid to each merchant in a chain of purchase “hops” could vary based on a number of different variables. In this system, whatever the variable used, merchant 410 is happy to pay a referral fee back to merchant 405 and even merchant 400. This is because merchant 410 knows its promotion at merchant 405 actually worked (i.e. resulted in a sale for merchant 410) and that the even earlier promotion of merchant 405's product at merchant 400 also worked (i.e. resulted in a confirmed sale for merchant 405).

The system described in this patent would allocate and keep track of those fee arrangements between merchant pairs in a simple list of merchant id pairs of a Current-Merchant id to Next-merchant id pairs and the arranged fee for the particular pair. The computer system for example would keep track of the source Merchant id for each completed sale. This Merchant id could be held in a system transaction database for each individual transaction or can be bundled into the receipt given to consumer 401. Someone skilled in the art of computer systems and databases that keep track of a series of simple payment transaction events can manage this. The preferred embodiment is to embed the Merchant id of the source merchant in the receipt provided to consumer 401 and in the sales transaction log of Component 5. The Merchant id's could be a combination of letters and numbers to increase the amount of variations of id values into a small id length in the system.

Each purchase creates a record of the distinct payment transaction data related to it, in a database for example or a simple list in Component 5 that is maintained by the system, that tracks the transaction source merchant id, destination merchant id, amount, and date and time.

At the end of each day the system could aggregate the number of purchases at merchant 405 and compute the sales agent fee for merchant 400 that needs to be paid. The system could possibly also assess a transaction and/or user fee to be paid to the Next-Hop system provider.

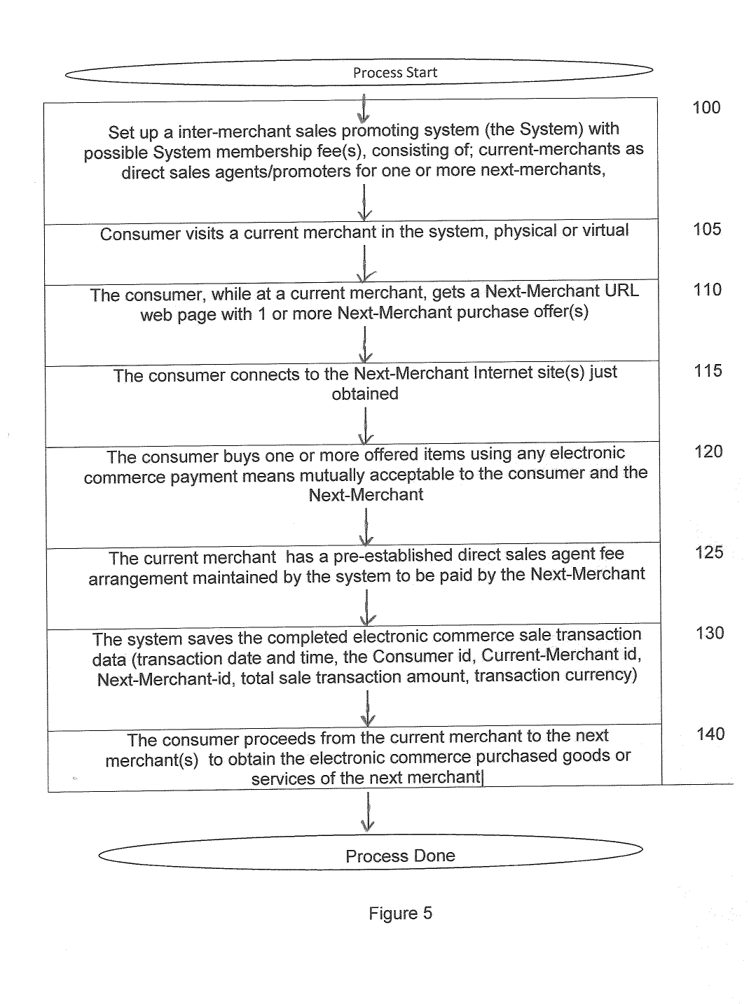

Turning to FIG. 5, this is a high level flow of the system.

The system begins, in step 100, by signing up and arranging pairs of merchants in an inter-merchant sales promoting network of such pairs (the System) with possible System membership fee(s), consisting of a Current-Merchant as direct sales agents/promoter for one or more Next-Merchants, each pair saved as a separate pair maintained by the System. Each merchant is identified by a unique system merchant id, with normal additional identity attributes such as the business name, address, legal business name, phone number, owner's name and contact information, email address, etc, as know in the art of having a customer data base or entity information listing for system participants. For each Current-Merchant a separate paired connection with each Next Merchant id connected to it together with an agreed sales agent fee for each Current-Merchant to Next-Merchant pair is saved, and be retrieved later by the system, that will convince a consumer, who registers their own unique id in the System, while at the Current-Merchant, to initiate and soon afterwards buy goods or services, through electronic commerce means, from the promoted Next-Merchant(s).

Then in step 105, the consumer visits a Current-Merchant in the system, physical or virtual. The process proceeds to step 110, where in a preferred embodiment, the consumer, while at a Current-Merchant, touches their own NFC enabled smart phone onto a physical poster there which has an embedded NFC tag with sends an Internet URL to the consumer's phone of a promoted Next-Merchant internet site.

The process proceeds to step 115, where the consumer connects to the Next-Merchant Internet site just obtained from the NFC poster, then to step 120, where the consumer, in a preferred embodiment, uses their own smart phone to buy one or more offered items using any electronic commerce payment means mutually acceptable to the consumer and that Next-Merchant.

The process proceeds to step 125 where the Current-Merchant has a pre-established direct sales agent fee arrangement to be paid by the next merchant maintained by the system of this invention. Then in step 130, the system of this invention saves the completed electronic commerce sale transaction data in a sequential list or data base of completed transactions with items such as transaction date and time, the consumer-id, current and next merchant-ids, total sale transaction amount, transaction currency in order to pay at some point in time the agreed sales agent fee(s) to the current and possible prior merchants and to the inter-merchant sales promoting system provider of this invention.

In step 140, the consumer proceeds from the Current-Merchant to the Next-Merchant(s) to obtain the electronic commerce purchased goods or services of the Next-Merchant.

### Preferred Embodiment

At minimum this system results in a consumer commitment to buy Merchant-2's product/service while at a different merchant site and provides a sales agent fee back to the referring merchant.

The consumer commits to at least one next purchase in the chain of merchants which allows for a possible chain reaction of even more transactions to continue to provide benefits and profits at each merchant in the Next-Hop merchant network. However, there is no requirement that a merchant provides more than one offer/incentive at a time.

Transactions are preferably separate so that Merchant-1's transaction is a distinct sales transaction from Merchant-2's sale transaction, at Merchant-1's location. In this option, there is no need to compute what part of a combined sales transaction goes to Merchant-1 and then Merchant-2.

There is provided a network of merchants that provides sales agent services for the benefit of the “Next-Merchant” in a chain of merchants, with an incentive system that enables a beginning merchant to get paid fees for the sales agent work it performs to get people to buy at a Next-Merchant, preferably nearby.

The system provides deals or values to consumers at merchants who most likely offer different products or services. This innovative system provides a reward for a consumer when he commits or pre-pays for a product or service of a “Next-Merchant.” The system rewards merchants for working together. This has not happened in this way before.

In one embodiment, a chain of linked merchants can be triggered when a consumer is near a targeted travel destination or in the general area of participating merchants so that consumers spend more locally within the system. The consumer prepays for each offer provided by each merchant from a linked network of merchants in the Next-Hop merchant network.

For example, a consumer creates a bundle of purchases such as a rental car, then a hotel 20 miles away, then a restaurant 5 miles from that hotel, and so on, all ahead of time, from merchants linked in the Next-Hop merchant network.

This is different than a cross marketing scheme for businesses using static/set coupons. This invention provides a live/evolving “dynamic” linked chain of different coupons offered by different merchants. A consumer can use one coupon or multiple linked coupons available in the chain network of merchants.

The pathway through the network is dynamically chosen by the consumer as they arrive at each merchant location and see what “Next-Hop” coupons are available at that particular merchant location.

This system links the physical merchants together into a mutually agreeable business relationship where one merchant (Merchant-1) becomes a paid sales agent for an agreed merchant (Merchant-2).

Preferably there is a separate distinct payment transaction initiated by the consumer at Merchant-1 through electronic commerce means for goods or services provided at a nearby physical or virtual merchant location (Merchant-2). There will be a means to track that this transaction for Merchant-2 was initiated by the consumer at a first merchant (physical or electronic), Merchant-1 so that the first Merchant-1 receives a fee as the “sale agent” for the completed electronic commerce transaction for goods or services provided at a Next-Merchant (Merchant-2).

This system incentivizes Merchant-1 through a payment by Merchant-2 to Merchant-1 to offer this service. Merchant-1 gets paid by Merchant-2 through this system to enable special offerings for Merchant-2.

Merchant-1 has an immediate financial incentive so that Merchant-1 is motivated to promote a Merchant-2 offering at a Merchant-1 location.

In a preferred embodiment, Merchant-1's services would be fully paid for and committed by the consumer at the time Merchant-2's offer is made. However, this system does not mandate that a committed transaction at Merchant-1 be made in order to get Merchant-2's offer committed and made. This is because Merchant-2 will be paying a fee to Merchant-1 for their sales agent role whether or not the consumer completes the transaction for Merchant-1 services. A consumer could reject Merchant-1's product but still take the offer made through Merchant-1 for Merchant-2's product.

For example, if a consumer goes to a first merchant like a Red Box Movie Kiosk to rent a movie, and while in that process is presented an offer from a nearby pizza place for 50% off pizza right now, the consumer might chose to not complete the movie rental at that moment and decide instead to opt to buy the pizza right now. The consumer would pay and commit for the pizza while at the movie rental box in a separate electronic commerce enabled transaction for pizza occurring at the rental box's location. In this invention, the system still rewards Merchant-1 for its efforts in promoting Merchant-2's product. Through the business fee agreement, the pizza place could be asked to pay a higher fee to Merchant-1 because of its efforts in drawing in a new Merchant-2 consumer even if the consumer only decides to use Merchant-2's services and not use Merchant-1's services.

The system payment from Merchant-1 to Merchant-2 is effectuated through electronic commerce means well known in the art. Note that any method of payment is supported.

The consumer is in a “buying mood” aka “shopping mode” and is transacting at Merchant-1.

For example, if you are buying a movie ticket online, this system for instance could make you an offer to additionally purchase pizza at a nearby Merchant-2 location. The unique part of this patent is that Merchant-1 is incented to provide these offers for nearby merchants because Merchant-1 is getting a sales agent fee to do so from Merchant-2.

In one preferred embodiment, the user is physically showing up at Merchant-1 and uses his NFC capable phone to tap a NFC “smart” poster describing a coupon or offer. The poster itself has a NFC tag embedded inside which fully explains the offer being made by Merchant-2 within Merchant-1's location. The consumer then taps his phone against that poster and through NFC Forum standard operations is shown the website of this system for Merchant-2 on his phone. As a result, the product or service being offered can be purchased right there in real time by the consumer from his phone, and payment can be made for the product or service of Merchant-2, using payments procedures well known in the art. This system tracks the fact that a purchase has been made storing data elements such as a onetime code, or barcode, or unique system transaction number that would provide evidence that the system is tracking the purchase and the purchase has been entered into the system, and approved or denied, and if approved, a transaction code or receipt as proof of purchase is given back to the consumer on his phone so he can go to Merchant-2 and consume the just purchased good or service.

In one preferred embodiment, the goods/service being offered by Merchant-2 should be of such clear and obvious value that most consumers will interact with the smart poster in Merchant-1's physical location.

The system provides for a payment for goods or services for a Merchant-2 while the consumer is in Merchant-1's location. In one embodiment, this could be implemented by a Merchant-1 computer at Merchant-1's location.

The transaction for the electronic commerce payment could use standard SSL encryption to protect the transaction data or MasterCard's SecureCode or Visa's 3D Secure Internet payment methods or other methods know in the art.

The system allows for an additional fee for “next hop” priority positioning of any subsequent merchant's offer. How the system arrives at these rates could be through statistical analysis used in the art.

The system also allows for the preferred or flexible placement of the Next-Merchant offer (Merchant-2, Merchant-3, and so on) depending on day of the week, time of the day, time of the year, or other criteria. As the time element changes the priority or preferred position, so could the fee.

Furthermore, the system is enabled to accommodate linkages which reflect the positioning of typical consumer behavior patterns that are grouped together like going to a movie, then getting something to eat, then going shopping for the day, and finally refilling your tank with gas. This type of “activity grouping” could be enhanced based on the quantity of consumers or type of good consumed. For example if you bought a single ticket for a movie, you might get an offer for a single discounted slice of pizza. If you purchased 5 movie tickets for the family, you might be offered a larger dinner size package at an even better discount.

However, merchants can provide additional benefits beyond discounted offers. One possibility is Merchant-1 and Merchant-2 can give special treatment to the specific class of consumers who exclusively shop at either location. Merchant-1 can be empowered to label its consumers “special” and grant them higher status when they arrive at Merchant-2. This status could then let consumers bypass any lines at Merchant-2 or get them premier seating at a newly opened show. Through this system Merchant-1 and 2 can easily opt into a reciprocal preferential treatment program to exchange high valued consumers.

I claim:

1. A method for incenting a current merchant to be a paid sales agent for a next merchant to have a consumer conduct a financial transaction through electronic commerce means that is initiated at a current merchant for goods or services of a next merchant comprising, completing said financial transaction with the next merchant through electronic commerce who is paired to the current merchant, who receives an agreed sales agent fee paid to the current merchant, and a potential sales agent fee to merchants previous to the current merchant who made the current sale possible, thereby having the consumer involved in a dynamic network of paired merchants, with merchants themselves as paid sales agents for other merchants

2. A method of claim 1 where the current merchant and next merchant conduct their business from physical locations or storefronts.

3. A method of claim 1 where the current merchant conducts their business from a physical location or storefront and the next merchant conducts their business in an electronic commerce storefront or non-physical location or the current merchant conducts their business from a virtual electronic commerce location or storefront and the next merchant conducts their business in a physical storefront or location.

4. A method of claim 1 where the current merchant conducts their business from a electronic commerce storefront or non-physical location and the next merchant also conducts their business in an electronic commerce storefront or non-physical location.

5. A processor implemented method for delivering and completing a purchase of goods or services of a next-merchant while the consumer is at a current-merchant, which computer-implemented method providing a call to action for the consumer at the current-merchant to commit, complete, and pay for the purchase for the next-merchant's goods or services while the consumer is present at the current-merchant with a computer-implemented means for that next-merchant to pay an agreed sales commission fee to the current-merchant, completed by the consumer at the current-merchant within a defined time frame or within a geographic boundary or within a combination of time frame and geographic boundary, which processor implemented method creating a network of merchants promoting a next-merchant's goods or services, where these steps are performed by at least one processor.

6. A method of claim 5 where a computer-implemented means for a next-physical-merchant to pay an agreed sales commission to the current physical merchant, and other previous physical merchants in a defined chain of one or more linked purchases completed by the consumer at a next-physical-merchant within a defined time frame or within a geographic boundary or within a combination of time frame and geographic boundary, while at a current physical-merchant, where there is a defined chain of one or more linked purchases completed prior to the current purchase by the consumer at a physical-merchants within a defined time frame or within a geographic boundary or within a combination of time frame and geographic boundary, which processor implemented method creating a network of physical-merchants which includes a sales agent fee or fees allocated and paid to previous current-merchants in a chain of previous purchases, where these steps are performed by at least one processor.

7. The method of claim 5 wherein the current merchant offers goods and services of a next merchant who is physically nearby the current merchant increasing the likelihood that the consumer will purchase the goods or services from the next-merchant, and the consumer completing the sale for the next-merchant while at the current-merchant.

8. The method of claim 5 wherein the current-merchant offers goods and services of a next-merchant who is offering goods or services that are different, a supplement, or of possible next purchase interest to the consumer.

9. The method of claim 5 wherein the current merchant offers goods and services of a next-merchant who is physically near the consumer's home address increasing the likelihood that the consumer will purchase the goods or services from that next-merchant near their home, and the consumer completing the sale for the next-merchant while at the current-merchant.

10. A system with a processor and memory configured to execute software instructions in an electronic device for presenting and completing electronic commerce purchase offers made to consumers at a current-merchant for goods or services at a next-merchant with the following components;
a component listing and maintaining for each current-merchant one or more paired next-merchants and corresponding sales offer and sales terms for each next-merchant
An “Electronic Commerce Transaction Initiating Device” (EC-TID) from the merchant or consumer that can initiate and complete an electronic commerce purchase transaction
A consumer entity component for each consumer who uses the system
A current-merchant component for each Current-Merchant including a list of each Next-Merchant and their corresponding internet web site used for this Current-Merchant pairing relationship, sales agent fee and sales commission terms for any merchants previous to this Current-Merchant
Next-Merchant component with has items/services offered for sale by this Next-Merchant for consumer's at each particular Current-Merchant connected to this Next-Merchant and sales commission terms for a Next-Merchant to Current-Merchant pair
List of purchases made by each consumer initiated from a Current-Merchant for goods/services of a Next-Merchant

11. A system of claim 10 where the sales terms includes non-monetary value, such as faster average service, or service to go to the front of a line, and does not only provide direct monetary value.

12. A system providing an electronic commerce purchase offer to a consumer at a current-merchant for a good or service provided by a next-merchant, comprising the steps of: having an electronic commerce purchase device available to the consumer at a current-merchant initiating an electronic commerce purchase wherein one or multiple next-merchant(s) present electronic commerce provided purchase offer(s) for goods or services at their next-merchant location(s) which are shown on the electronic computing device available at the current-merchant, wherein the electronic commerce initiated purchase offer on the current-merchant electronic commerce initiating device provides a means for the consumer to pay and complete the purchase of goods or services at a next-merchant, and possibly continuing to purchase goods or services at a second, third or more next merchants, each next-merchant transaction processed and handled as a standalone and separate sale transaction to accommodate different payment methods and means potentially used by each next-merchant, each purchase transaction processed individually as a separate purchase transaction, using an electronic commerce payment method acceptable by the particular next-merchant, which the consumer picks while at or in the area of the current-merchant using any accepted electronic commerce payment means; providing for sending and storing the details of the sale and/or sale receipt for distribution to the consumer and next-merchant through multiple possible methods to provide enough information to the next-merchant and consumer as proof of sale to use or obtain the just purchased next-merchant good or service the consumer bought while present at the current-merchant.

13. The system of claim 12 wherein the electronic commerce purchase initiating computing device is a portable electronic device.

14. The system of claim 12 wherein the next-merchant location is a physical location near the location the consumer lives, which location is provided by the consumer during the electronic commerce initiated purchase of the goods or services or is held and then obtained from a computer storage area of a consumer's account held in the system.

15. The system of claim 12 further comprising the step of: retrieving a list of one or more next-merchant purchase offers from the current-merchant each time the consumer is physically present at the current-merchant.

16. The system of claim 12 further comprising the step of: receiving a plurality of purchase offers from one or more next-merchants on an electronic computing device present at a current-merchant, which each of the plurality of purchase offers having the next-merchant's geographic location information defined therein, wherein receiving the plurality of purchase offers on the electronic device at the current-physical merchant.

17. The system of claim 12 further comprising the step of: receiving a machine readable code in the electronic commerce initiating device and making the code useable by printing it on paper, displaying it on a device the consumer has access to, or sending it to a device the consumer possess, wherein the machine readable code is usable at the next-merchant who validates and then provides the just purchased goods or services using machine readable means to verify the machine readable code.

18. A system of a network of current-merchants connected to a plurality of 1 or more next-merchant(s), with each link of current-merchant to next-physical merchant with attributes than can be different per connection link, for a consumer to initiate and complete an electronic commerce purchase using an electronic commerce purchase transaction initiating device present at the current-merchant for goods or services offered by a next-merchant, the system comprising:
an electronic commerce purchase transaction initiating device present at the current-merchant location, electronic commerce sale software to conduct an electronic commerce purchase transaction for goods or services at a next-merchant in a paired relationship with the current-merchant, the software in the electronic commerce device at the current-merchant operative to initiate and complete an electronic commerce initiated sale for goods or services at a next-merchant;
display, print or transmit the completed sales transaction data to the electronic-commerce-device at the current-merchant; wherein the electronic-commerce-initiating-device is operative to transmit the completed sale information in real-time over the wireless local area network to at least one database server to be recorded in at least one system database.

19. The system of claim 18, wherein the purchase information consists of:
purchased product identification, item quantity, item price, timestamp, real physical location of the next-merchant, and completed paid transaction amount.
